(19) United States
(12) Patent Application Publication
(10) Pub. No.: US 2017/0070940 A1
(43) Pub. Date: Mar. 9, 2017

(54) Systems and Methods for Managing Carrier Transmission After a Tune-Away

(71) Applicant: QUALCOMM Incorporated, San Diego, CA (US)

(72) Inventors: Omesh Kumar Handa, Carlsbad, CA (US); Sharif Ahsanul Matin, San Diego, CA (US); Ramesh Chandra Chirala, San Diego, CA (US); Yuan Wang, San Diego, CA (US); Manish Jain, Santa Clara, CA (US)

(21) Appl. No.: 14/844,149

(22) Filed: Sep. 3, 2015

(51) Int. Cl. H04W 40/02; H04W 24/08; H04W 72/04

(52) U.S. Cl. CPC H04W 40/02; H04W 72/0453; H04W 24/08

(57) ABSTRACT

Various embodiments for managing carrier transmissions after a tune-away on a wireless communication device may include determining whether a network has received transmissions from a first carrier of a first subscription after completion of the tune-away from the first subscription to a second subscription. In response to determining that the network has not received transmissions from the first carrier, the wireless communication device may determine whether a second carrier of the first subscription is transmitting to the network after completion of the tune-away. In response to determining that the second carrier is not transmitting to the network, the wireless communication device may route transmission from the first carrier to the second carrier.

### BACKGROUND

Some designs of wireless communication devices—such as smart phones, tablet computers, and laptop computers—contain one or more Subscriber Identity Module (SIM) cards that provide users with access to multiple separate mobile telephony networks. Examples of mobile telephony networks include Third Generation (3G), Fourth Generation (4G), Long Term Evolution (LTE), Time Division Multiple Access (TDMA), Frequency Division Multiple Access (FDMA), Code Division Multiple Access (CDMA), Wideband CDMA (WCDMA), Time Division Synchronous CDMA (TD-SCDMA), Global System for Mobile Communications (GSM), and Universal Mobile Telecommunications Systems (UMTS).

A wireless communication device that includes one or more SIMs and connects to two or more separate mobile telephony networks using one or more shared radio frequency (RF) resources/radios may be termed a multi-SIM-multi-standby (MSMS) communication device. One example is a dual-SIM dual-standby (DSDS) communication device, which includes two SIM cards/subscriptions that are each associated with a separate radio access technology (RAT). In DSDS communication devices the separate RATs share one RF resource chain to communicate with two separate mobile telephony networks on behalf of their respective subscriptions. When one RAT is using the RF resource, the other RAT is in stand-by mode and is not able to communicate using the RF resource.

One consequence of wireless communication devices configured to support a plurality of RATs that maintain network connections simultaneously is that the RATs may sometimes interfere with each other's communications. For example, two RATs on a DSDS communication device utilize a shared RF resource to communicate with their respective mobile telephony networks, and only one RAT can use the RF resource to communicate with its mobile network at a time. Even when a RAT is in an “idle-standby” mode, meaning that the RAT is not actively communicating with the network, the RAT may still need to periodically receive access to the shared RF resource in order to perform various network operations. For example, an idle RAT may need the shared RF resource at regular intervals to perform idle-mode operations to receive network paging messages in order to remain connected to the network, etc. on behalf of the RAT's subscription.

In conventional wireless communication devices, the idle RAT may occasionally interrupt the active RAT's RF operations so that the idle RAT may use the shared RF resource to perform the idle RAT's idle-standby mode operations (e.g., paging monitoring and decoding, cell reselection, system information monitoring, etc.). This process of switching access of the shared RF resource from the active RAT to the idle RAT is referred to herein as a “tune-away,” as the RF resource tunes away from the active RAT's frequency band or channel and tune to the idle RAT's frequency bands or channels. After the idle RAT has finished network communications, access to the RF resource may switch from the idle RAT to the active RAT via a “tune-back” operation.

### SUMMARY

Various embodiments include methods implemented on a wireless communication device for managing carrier transmissions after a tune-away, the wireless communication device having a first subscription and a second subscription. Various embodiments may include determining whether a first network associated with the first subscription has received transmissions from a first carrier of the first subscription after completion of the tune-away from the first subscription to the second subscription, determining whether a second carrier of the first subscription is transmitting to the first network after completion of the tune-away in response to determining that the first network has not received transmissions from the first carrier, and routing transmissions from the first carrier to the second carrier in response to determining that the second carrier is not transmitting to the first network.

In some embodiments, determining whether the first network has received transmissions from the first carrier may include determining an error rate for the first carrier for a time duration after completion of the tune-away, and determining whether the error rate for the first carrier is 100%. In some embodiments, the time duration may include an amount of time required for an initial transmission and all retransmissions of a hybrid automatic repeat request (HARQ) packet. In some embodiments, the error rate may be determined from a number of acknowledgements or non-acknowledgements received from the first network in response to the transmissions from the first carrier.

Some embodiments may further include determining whether the first network has received transmissions from the second carrier, and deactivating the first carrier in response to determining that the first network has received transmissions from the second carrier. In some embodiments, determining whether the first network has received transmissions from the second carrier may include determining an error rate for the second carrier, determining whether the error rate for the second carrier is 100%, and determining that the first network has received transmissions from the second carrier in response to determining that the error rate for the second carrier is less than 100%. Some embodiments may further include keeping the first carrier activated in response to determining that the first network has not received transmissions from the second carrier. In some embodiments, the first carrier may be a secondary uplink carrier and the second carrier may be a primary uplink carrier of a dual carrier high-speed uplink packet access call.

Further embodiments include a wireless communication device including a memory and a processor configured with processor-executable instructions to perform operations of the methods described above. Further embodiments include a non-transitory processor-readable storage medium having stored thereon processor-executable software instructions configured to cause a processor of a wireless communication device to perform operations of the methods described above. Further embodiments include a wireless communication device that includes means for performing functions of the operations of the methods described above.

### BRIEF DESCRIPTION OF THE DRAWINGS

The accompanying drawings, which are incorporated herein and constitute part of this specification, illustrate exemplary aspects of the various embodiments, and together with the general description and the detailed description given herein, serve to explain the features of the embodiments.

FIG. 1 is a communication system block diagram of a network suitable for use with various embodiments.

FIG. 2 is a block diagram illustrating a wireless communication device according to various embodiments.

FIG. 3 is a communication flow diagram illustrating conventional carrier transmissions between a wireless communication device and a network after a tune-away.

FIG. 4 is a communication flow diagram illustrating control of carrier transmissions on a wireless communication device after a tune-away according to various embodiments.

FIG. 5 is a process flow diagram illustrating a method of managing carrier transmissions after a tune-away on a wireless communication device according to various embodiments.

FIG. 6 is a component diagram of an example wireless communication device suitable for use with various embodiments.

### DETAILED DESCRIPTION

Various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the embodiments or the claims.

As used herein, the terms “SIM,” “SIM card,” and “subscriber identification module” are used interchangeably to refer to a memory that may be an integrated circuit or embedded into a removable card, and that stores an International Mobile Subscriber Identity (IMSI), related key, and/or other information used to identify and/or authenticate a wireless communication device on a network and enable a communication service with the network. Because the information stored in a SIM enables the wireless communication device to establish a communication link for a particular communication service or services with a particular network, the term “SIM” is also be used herein as a shorthand reference to the communication service associated with and enabled by the information stored in a particular SIM as the SIM and the communication network, as well as the services and subscriptions supported by that network, correlate to one another. Similarly, the term SIM may also be used as a shorthand reference to the protocol stack and/or modem stack and communication processes used in establishing and conducting communication services with subscriptions and networks enabled by the information stored in a particular SIM.

As used herein, the terms “wireless communication device,” “multi-SIM communication device” and “multi-SIM wireless communication device” are used interchangeably to describe a wireless communication device that is configured to receive more than one SIM and support multiple subscriptions associated with the multiple SIMs.

The terms “network,” “wireless network,” “cellular network,” and “cellular wireless communication network” are used interchangeably herein to refer to a portion or all of a wireless network of a carrier associated with a wireless communication device and/or subscription on a wireless communication device.

Modern wireless communication devices (e.g., smartphones) may be configured to accept multiple SIM cards containing SIMs that enable the same wireless communication device to connect to different mobile networks. Each SIM serves to identify and authenticate a subscriber using a particular wireless communication device, and each SIM is typically associated with only one subscription. For example, a SIM may be associated with a subscription to one of LTE, GSM, CDMA, TD-SCDMA, or WCDMA.

An MSMS wireless communication device, for example a DSDS device, may include multiple SIMs associated with multiple subscriptions that share an RF resource. The RF resource may include one or more receivers, transmitters, and/or transceivers and one or more antennas. A subscription on the wireless communication device may be configured with a single transmit chain that includes dual carriers: a primary uplink carrier and a secondary uplink carrier. These carriers may be used to transmit data to a network associated with the subscription. In some embodiments, the secondary uplink carrier may be inactive by default, and is activated by a command from a network base station (e.g., eNodeB). In some embodiments, when the secondary uplink carrier is active it may be the default transmission carrier while the primary uplink carrier may be used for overflow data transmission.

The dual carrier transmit chain on the subscription may be configured to operate with high speed uplink packet access (HSUPA). During dual carrier HSUPA operations, the activation and deactivation of the secondary uplink carrier is controlled via a high speed shared control channel (HS-SCCH). The network may send HS-SCCH messages to the wireless communication device to order the activation or deactivation of the secondary uplink carrier (i.e., activate or deactivate dual carrier HSUPA).

The wireless communication device may occasionally perform tune-aways from a dual carrier transmit chain on an active subscription to an idle subscription. During the tune-away, the network of the dual carrier transmit chain subscription may sometimes send an activate or deactivate command to the wireless communication device to activate or deactivate the secondary uplink carrier. However, because the wireless communication device has tuned away from the dual carrier transmit chain subscription, the wireless communication device will not receive the command, which may cause problems for the active subscription after the tune-away is complete.

If the missed command is a command to activate the secondary uplink carrier, the wireless communication device may continue to transmit only on the primary uplink carrier after the tune-away is complete. This may lead to a lower transmission throughput as the secondary uplink carrier is not utilized.

If the missed command is a command to deactivate the secondary uplink carrier, the wireless communication device may continue to transmit using the secondary uplink carrier after the tune-away is complete. However, the network is no longer accepting transmissions from the secondary uplink carrier as the network already considers it deactivated. Thus, none of the data transmitted by the secondary uplink carrier may be received by the network. This may result in a radio link control (RLC) window stall and a drop of the data call on the subscription.

Systems, methods, and devices of various embodiments enable a wireless communication device to detect and manage missed control messages to deactivate a secondary carrier after completion of a tune-away. The wireless communication device may be a MSMS device, for example a DSDS device, and may include a first subscription having a first carrier and a second carrier (e.g., a primary uplink carrier and secondary uplink carrier), and a second subscription. A processor in the wireless communication device, for example a modem processor, may determine whether a network has received transmissions from the first carrier (e.g., secondary uplink carrier) after completion of the tune-away from the first subscription to the second subscription. For example, the processor may collect error rate statistics for a time duration T, which may be the amount of time for an initial transmission and all retransmissions for one hybrid automatic repeat request (HARQ) packet transmission. If the network does not send any acknowledgements (ACKs) (i.e., 100% HARQ indicator channel (HICH) discontinuous transmissions (DTx), or 100% residual block error rate) for the attempted transmission, this may indicate that the network is not receiving any transmissions from the first carrier. One cause for the network not receiving any transmissions from the first carrier could be that the wireless communication device missed a deactivation command from the network that deactivated the first carrier during the tune-away.

The processor may determine whether the second carrier (e.g., primary uplink carrier) is transmitting to the network after completion of the tune-away in response to determining that the network has not received transmissions from the first carrier. The processor may route transmission from the first carrier to the second carrier in response to determining that the second carrier is transmitting to the network. The processor may determine whether the network is receiving transmissions from the second carrier. If so, the processor may deactivate the first carrier and proceed with normal transmission processes on the second carrier.

In the following descriptions of various embodiments, references made to a first subscription and a second subscription, or a first carrier and a second carrier, are arbitrary and used merely for the purposes of describing the embodiments. The wireless communication device processor may assign any indicator, name or other designation to differentiate the subscriptions associated with one or more SIMs, or to carriers within a multi-carrier subscription.

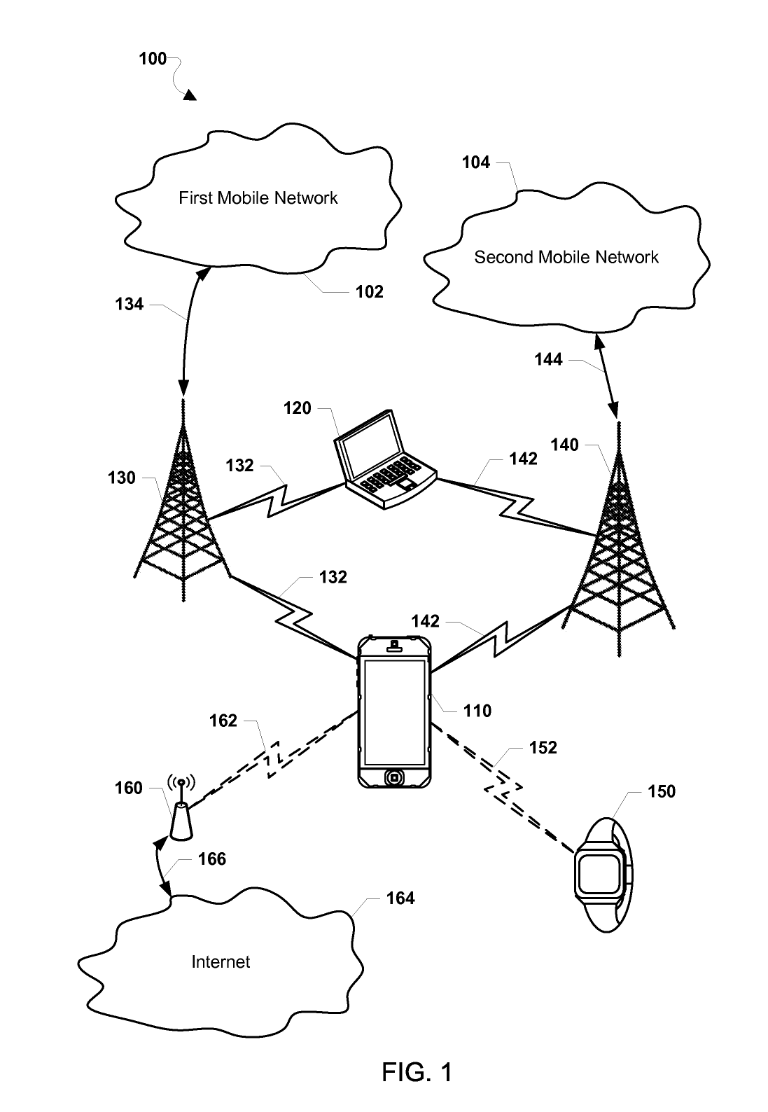

Various embodiments may be implemented within a variety of communication systems 100, such as at least two mobile telephony networks, an example of which is illustrated in FIG. 1. A first mobile network 102 and a second mobile network 104 typically each include a plurality of cellular base stations (e.g., a first base station 130 and a second base station 140). A first wireless communication device 110 may be in communication with the first mobile network 102 through a cellular connection 132 to the first base station 130. The first wireless communication device 110 may also be in communication with the second mobile network 104 through a cellular connection 142 to the second base station 140. The first base station 130 may be in communication with the first mobile network 102 over a wired connection 134. The second base station 140 may be in communication with the second mobile network 104 over a wired connection 144.

A second wireless communication device 120 may similarly communicate with the first mobile network 102 through the cellular connection 132 to the first base station 130. The second wireless communication device 120 may also communicate with the second mobile network 104 through the cellular connection 142 to the second base station 140. The cellular connections 132 and 142 may be made through two-way wireless communication links, such as Third Generation (3G), Fourth Generation (4G), Long Term Evolution (LTE), Time Division Multiple Access (TDMA), Code Division Multiple Access (CDMA), Wideband CDMA (WCDMA), Global System for Mobile Communications (GSM), Universal Mobile Telecommunications Systems (UMTS), and other mobile telephony communication technologies.

While the wireless communication devices 110, 120 are shown connected to the first mobile network 102 and, optionally, to the second mobile network 104, in some embodiments (not shown), the wireless communication devices 110, 120 may include two or more subscriptions to two or more mobile networks and may connect to those subscriptions in a manner similar to those described herein.

In some embodiments, the first wireless communication device 110 may optionally establish a wireless connection 152 with a peripheral device 150 used in connection with the first wireless communication device 110. For example, the first wireless communication device 110 may communicate over a Bluetooth® link with a Bluetooth-enabled personal computing device (e.g., a “smart watch”). In some embodiments, the first wireless communication device 110 may optionally establish a wireless connection 162 with a wireless access point 160, such as over a Wi-Fi connection. The wireless access point 160 may be configured to connect to the Internet 164 or another network over a wired connection 166.

While not illustrated, the second wireless communication device 120 may similarly be configured to connect with the peripheral device 150 and/or the wireless access point 160 over wireless links.

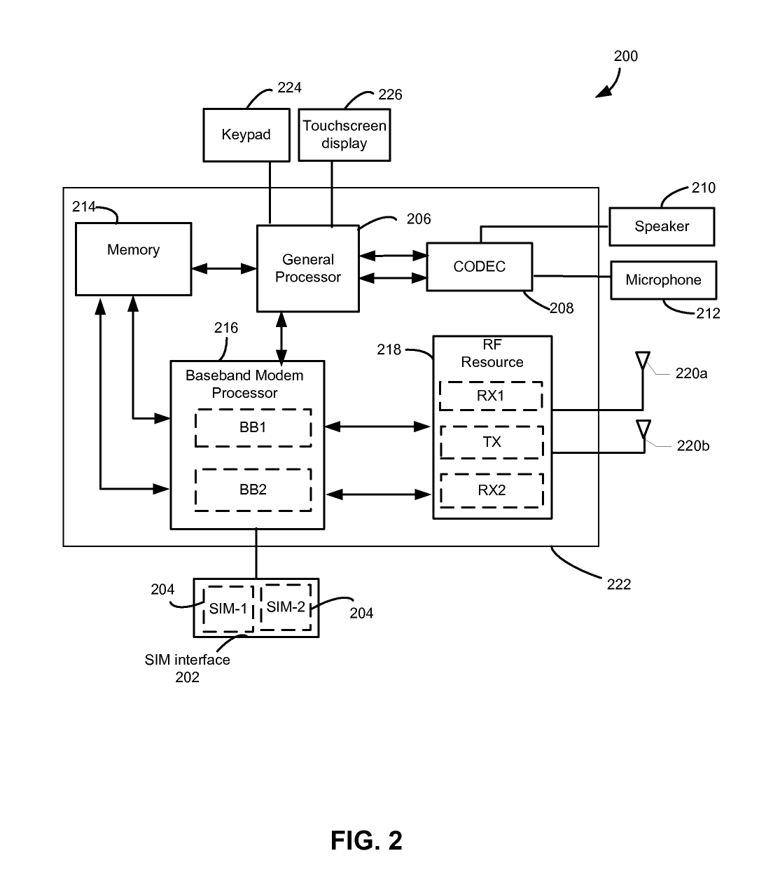

FIG. 2 is a functional block diagram of an example multi-SIM communication device 200 that is suitable for implementing various embodiments. With reference to FIGS. 1-2, the multi-SIM communication device 200 may be similar to one or more of the wireless communication devices 102. The multi-SIM communication device 200 may include a SIM interface 202, which may represent either one or two SIM interfaces. The SIM interface 202 may receive a first identity module SIM 204 that is associated with the first subscription. In some embodiments, the multi-SIM communication device 200 may also include a second SIM interface as part of the SIM interface 202, which may receive a second identity module SIM 204 that is associated with a second subscription.

A SIM in various embodiments may be a Universal Integrated Circuit Card (UICC) that is configured with SIM and/or Universal SIM applications, enabling access to GSM and/or UMTS networks. The UICC may also provide storage for a phone book and other applications. Alternatively, in a CDMA network, a SIM may be a UICC removable user identity module (R-UIM) or a CDMA subscriber identity module (CSIM) on a card.

Each SIM 204 may have a central processing unit (CPU), read only memory (ROM), random access memory (RAM), electrically erasable programmable read only memory (EEPROM) and input/output (I/O) circuits. A SIM 204 used in various embodiments may contain user account information, an IMSI a set of SIM application toolkit (SAT) commands and storage space for phone book contacts. A SIM 204 may further store home identifiers (e.g., a System Identification Number (SID)/Network Identification Number (NID) pair, a Home Public Land Mobile Number (HPLMN) code, etc.) to indicate the SIM network operator provider. An Integrated Circuit Card Identity (ICCID) SIM serial number may be printed on the SIM card for identification.

The multi-SIM communication device 200 may include at least one controller, such as a general purpose processor 206, which may be coupled to a coder/decoder (CODEC) 208. The CODEC 208 may in turn be coupled to a speaker 210 and a microphone 212. The general purpose processor 206 may also be coupled to at least one memory 214. The memory 214 may be a non-transitory tangible computer readable storage medium that stores processor-executable instructions. For example, the instructions may include routing communication data relating to the first or second subscription though a corresponding baseband-RF resource chain. The memory 214 may store operating system (OS), as well as user application software and executable instructions. The memory 214 may also store quality metrics for various channels supported by the SIMs 204 and the RF resource 218.

The general purpose processor 206 and memory 214 may each be coupled to at least one baseband-modem processor 216. Each SIM 204 in the multi-SIM communication device 200 may be associated with a baseband-RF resource chain that includes a baseband-modem processor 216 and at least one receive block (e.g., RX1, RX2) of an RF resource 218. In various embodiments, baseband-RF resource chains may include physically or logically separate baseband modem processors (e.g., BB1, BB2).

The RF resource 218 may be coupled to antennas 220a, 220b, and may perform transmit/receive functions for the wireless services associated with each SIM 204 of the multi-SIM communication device 200. In some embodiments, the RF resource 218 may be coupled to wireless antennas 220a, 220b for sending and receiving RF signals for multiple SIMs 204 thereby enabling the multi-SIM communication device 200 to perform simultaneous communications with separate networks and/or service associated with the SIM(s) 204. The RF resource 218 may include separate receive and transmit functionalities, or the RF resource 218 may include a transceiver that combines transmitter and receiver functions. In various embodiments, the transmit functionalities of the RF resource 218 may be implemented by at least one transmit block (TX), which may represent circuitry associated with one or more radio access technologies/SIMs

In some embodiments, the general purpose processor 206, memory 214, baseband-modem processor(s) 216, and RF resource 218 may be included in a system-on-chip device 222. The one or more SIM 204 and corresponding interface(s) 202 may be external to the system-on-chip device 222. Further, various input and output devices may be coupled to components of the system-on-chip device 222, such as interfaces or controllers. Example user input components suitable for use in the multi-SIM communication device 200 may include, but are not limited to, a keypad 224 and a touch screen display 226.

In some embodiments, the keypad 224, touch screen display 226, microphone 212, or a combination thereof, may perform the function of receiving the request to initiate an outgoing call. For example, the touch screen display 226 may receive a selection of a contact from a contact list or receive a telephone number. In another example, either or both of the touch screen display 226 and microphone 212 may perform the function of receiving a request to initiate an outgoing call. For example, the touch screen display 226 may receive selection of a contact from a contact list or receive a telephone number. As another example, the request to initiate the outgoing call may be in the form of a voice command received via the microphone 212. Interfaces may be provided between the various software modules and functions in the multi-SIM communication device 200 to enable communication between them, as is known in the art.

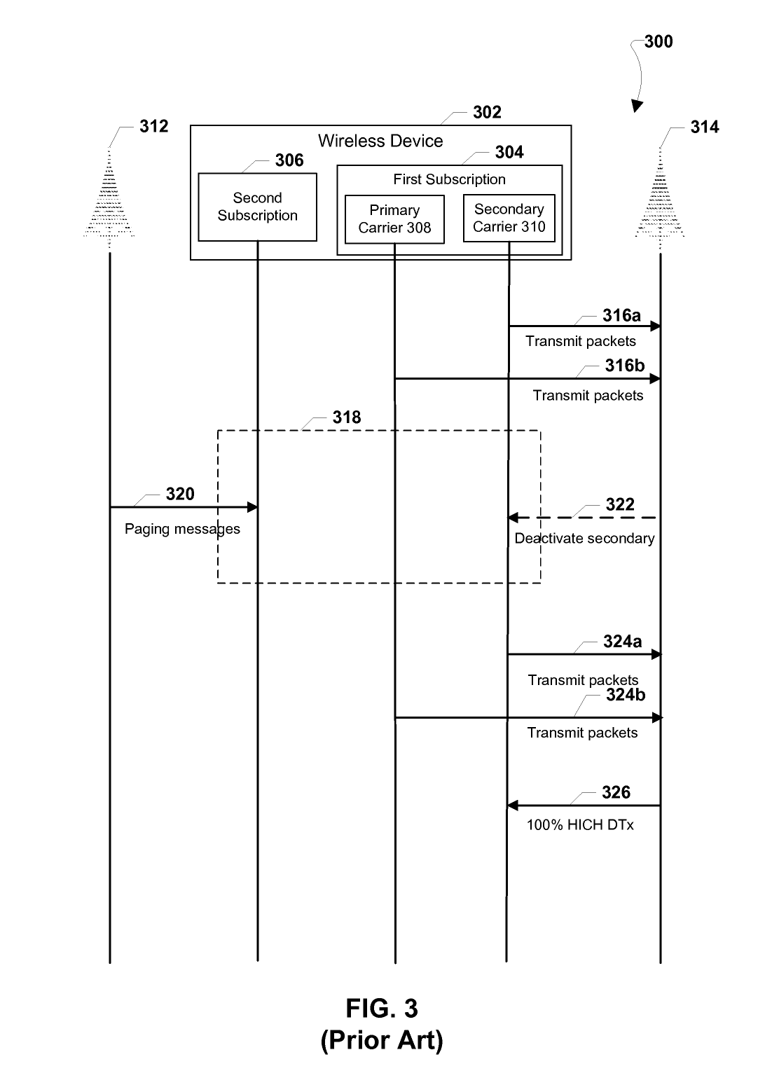

FIG. 3 includes a communication flow diagram 300 illustrating conventional communications between a wireless communication device 302, a first network 314 and a second network 312. The wireless communication device 302 may be a MSMS device, for example a DSDS device, with a first subscription 304 and a second subscription 306 sharing an RF resource. The first subscription 304 may be enabled for HSUPA communications on the transmit chain and may include a primary uplink carrier 308 and a secondary uplink carrier 310. The first subscription 304 may be associated with the first network 314 and may communicate using a certain RAT (e.g., LTE, WCDMA, CDMA, UMTS), while the second subscription 306 may be associated with the second network 312 and may communicate using another RAT (e.g., GSM). The wireless communication device 302 may be a single receive device (i.e., one receive chain) or a dual receive device (i.e., two receive chains).

The first subscription 304 may be active on a data call with the first network 314, transmitting data to the first network 314 using dual carrier HSUPA. The secondary carrier 310 may be the default transmission carrier and transmit packets to the first network 314 in transmission 316a. The primary carrier 308 may optionally also transmit packets to the first network 314 in transmission 316b (e.g., overflow data transmissions that exceed the bandwidth of the secondary carrier 310).

Periodically, the wireless communication device may perform a tune-away 318 (e.g., a quick tune-away or a long tune-away) from the first subscription 304 to the second subscription 306. During the tune-away 318, the second network 312 may send paging messages 320 and/or other information (e.g., neighbor cell measurements) to the second subscription 306. During the tune-away 318, the first subscription 304 may not be able to receive communications from the first network 314. For example, the first network 314 may send a HS-SCCH control message 322 to deactivate the secondary carrier 310. However, the control message 322 is not received by the wireless communication device 302 because of the tune-away 318.

Thus after the tune-away 318 is complete, the wireless communication device 302 may continue to transmit packets through the secondary carrier 310 in transmission 324a, and optionally through the primary carrier 308 as well in transmission 324b. The first network 314 may successfully receive and acknowledge receipt of the transmission 324b (e.g., by sending an ACK message). However, because the first network 314 considers the secondary carrier 310 deactivated, the first network 314 may not receive and thus may not acknowledge the transmission 324a. For example, the first network 314 may send one or more non-acknowledgements (NACKs) to the wireless communication device 302 that correspond to the transmission 324a, or simply not send any ACKs to the wireless communication device 302 in response to the transmission 324a. The wireless communication device 302 may attempt to retransmit the packets in the transmission 324a according to a HARQ protocol, but the first network 314 may not acknowledge any of the retransmissions either. This may lead to a 100% residual block error rate (BLER), or 100% HICH DTx condition 326 as the first network 314 does not receive any transmissions from the secondary carrier 310. This may result in a RLC window stall and call drop of the data call between the first subscription 304 and the first network 314.

Various embodiments include systems and methods that may detect missed control messages for a carrier during a tune-away and respond accordingly to avoid stalls and dropped calls. This may be accomplished by monitoring whether the network is receiving data transmitted by a secondary carrier and shifting the transmission to the primary carrier if the network is not receiving the transmitted data.

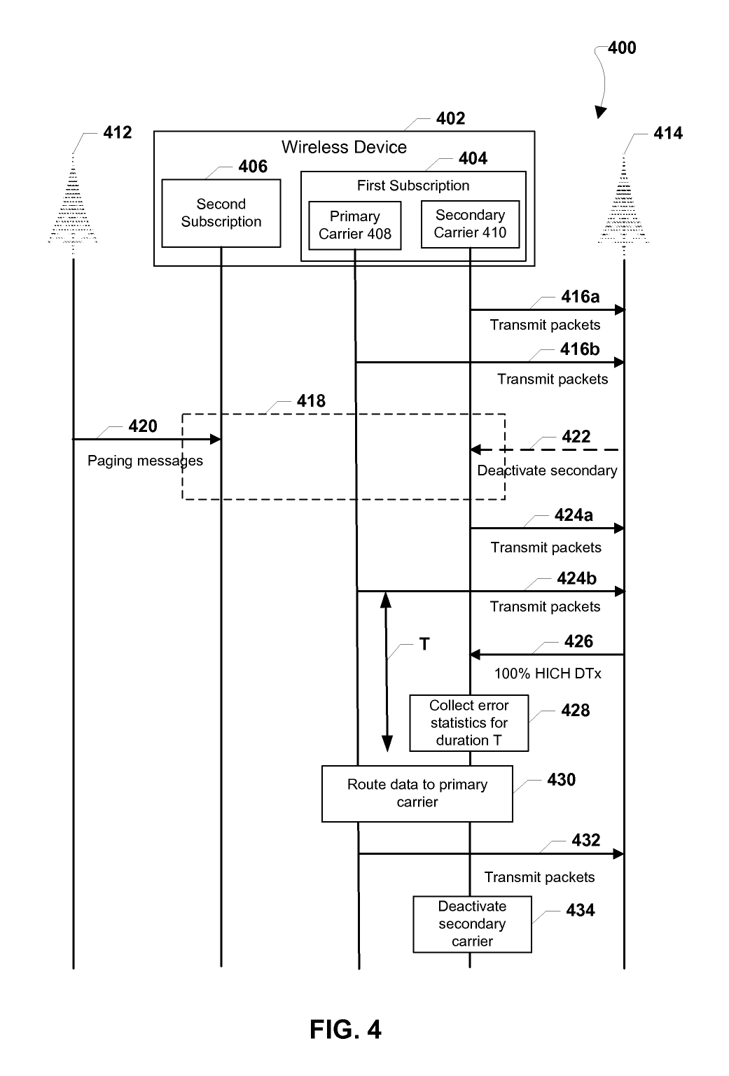

FIG. 4 includes a communication flow diagram 400 illustrating management of carrier transmissions between a wireless communication device 402, a first network 414, and a second network 412 according to various embodiments. With reference to FIGS. 1-2 and 4, the wireless communication device 402 may be a MSMS device, for example a DSDS device (e.g., 110 or 200), with a first subscription 404 and a second subscription 406 sharing an RF resource (e.g., 218). The first subscription 404 may be enabled for HSUPA communications and may include a primary uplink carrier 408 and a secondary uplink carrier 410. The first subscription 404 may be associated with the first network 414 and may communicate using a certain RAT (e.g., LTE, WCDMA, CDMA, UMTS, GSM), while the second subscription 406 may be associated with the second network 412 and may communicate using another RAT (e.g., GSM). The wireless communication device 402 may be a single receive device or a dual receive device.

The first subscription 404 may be active on a data call with the first network 414, transmitting data to the first network 414 using dual carrier HSUPA. The secondary carrier 410 may be the default transmission carrier and transmit packets to the first network 414 in transmission 416a. The primary carrier 408 may optionally also transmit packets to the first network 414 in transmission 416b (e.g., overflow data transmissions that exceed the bandwidth of the secondary carrier 410).

Periodically, the wireless communication device may perform a tune-away 418 (e.g., a quick tune-away or a long tune-away) from the first subscription 404 to the second subscription 406. During the tune-away 418, the second network 412 may send paging messages 420 and/or other information (e.g., neighbor cell measurements) to the second subscription 406. During the tune-away 418, the first subscription 404 will not be able to receive communications from the first network 414. Thus, if the first network 414 sends a HS-SCCH control message 422 to deactivate the secondary carrier 410, the control message 422 will not be received by the wireless communication device 402.

Thus, after the tune-away 418 is complete, the wireless communication device 402 may continue to transmit packets through the secondary carrier 410 in transmission 424a, and optionally through the primary carrier 408 as well in transmission 424b. The first network 414 may successfully receive and acknowledge receipt of the transmission 424b (e.g., by sending an acknowledgement (ACK) message). However, because the first network 414 deactivated the secondary carrier 410, the first network 414 may not receive or acknowledge the transmission 424a. For example, the first network 414 may send one or more NACKs to the wireless communication device 402 that correspond to the transmission 424a, or the first network 414 may simply not send any ACKs to the wireless communication device 402 in response to the transmission 424a.

In operation 428, the wireless communication device 402 may collect error statistics for the secondary carrier 410 for a time duration T after completion of the tune-away 418. The time duration T may be the time duration for the transmission 424a and all retransmissions of the transmission 424a according to the HARQ protocol. For example, the time duration T may be equal to the round trip time for a transmission between the wireless communication device 402 and the first network 414 multiplied by the number of HARQ retransmissions allowed (e.g., 4 or 8). The wireless communication device 402 may collect the block error rate (BLER) statistics for the secondary carrier 410 by determining the number of ACKs or NACKs received from the first network 414 in response to each transmission attempt for the same packet. If the first network 414 does not send any ACKs in response to the transmission 424a, the secondary carrier 410 has a 100% HICH DTx condition 426 (i.e., 100% residual BLER). This may be an indication that the wireless communication device 402 has missed a control message 422 deactivating the secondary carrier 410.

If the error statistics collected for the time duration T after completion of the tune-away 418 indicates that the first network 414 is not receiving any transmissions or retransmissions from the secondary carrier 410, the wireless communication device 402 may determine whether the primary carrier 408 is transmitting data during the time duration T. If the primary carrier has not been transmitting data during the time duration T, the wireless communication device 402 may route data transmission from the secondary carrier 410 to the primary carrier 408 in operation 430. Thus, the primary carrier 408 becomes the default transmission carrier and begins transmitting packets to the first network 414 in transmission 432.

The wireless communication device 402 may collect error statistics for the primary carrier 408 to determine whether the first network 414 is receiving the transmission 432. If the first network 414 receives the transmission 432 with minimal BLER or with BLER similar to the BLER that existed before the tune-away 418, the wireless communication device 402 may deactivate the secondary carrier 410 in operation 434. In other words, upon determining that the first network 414 is receiving transmissions from the primary carrier 408 but not the secondary carrier 410, the wireless communication device 402 may conclude that a control message 422 was missed and independently deactivate the secondary carrier 410 accordingly.

If the first network 414 is not receiving all or a portion of the transmission 432 from the primary carrier 408, this may be an indication that the channel conditions between the wireless communication device 402 and the first network 414 do not support reliable communications (e.g., exhibiting too little signal strength and/or so much noise or fading that transmissions by the wireless communication device 402 are not being received by the first network 414 or vice versa). Because this may likely be a problem external to the device, the wireless communication device 402 may continue with normal transmission processing and not deactivate the secondary carrier 410.

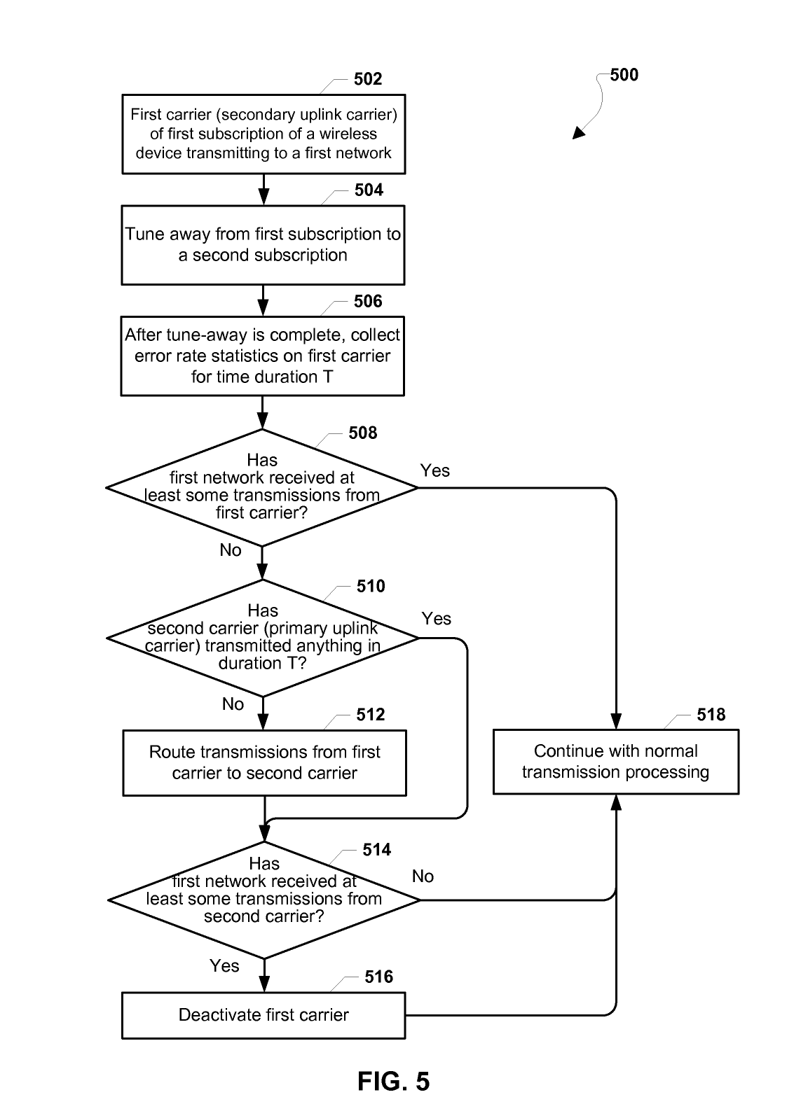

FIG. 5 illustrates a method 500 for managing carrier transmission after a tune-away on a wireless communication device according to various embodiments. With reference to FIGS. 1-2, and 4-5, the operations of the method 500 may be implemented by one or more processors of the multi-SIM communication device 200, such as a general purpose processor 206, a baseband modem processor(s) 216, or a separate controller (not shown) that may be coupled to the memory 214 and to the baseband modem processor(s) 216. The wireless communication device may be a MSMS device, for example a DSDS device with a first subscription and a second subscription sharing an RF resource. The first subscription may be enabled for HSUPA communications and may include a first carrier (e.g., a secondary uplink carrier) and a second carrier (e.g., a primary uplink carrier). The first subscription communicate with a first network using a certain RAT (e.g., LTE, WCDMA, CDMA, UMTS), while the second subscription may communicate with a second network using another RAT (e.g., GSM). The wireless communication device may be a single receive device or a dual receive device.

In block 502, the device processor may be transmitting data (e.g., on an active data call) through the first carrier of the first subscription to the first network. The second subscription may be idle and not utilizing the shared RF resource. The first carrier (e.g., secondary uplink carrier) may be the default transmission carrier for the first subscription. The second carrier (e.g., primary uplink carrier) may be an overflow transmission carrier. The second carrier may also be transmitting data. The first carrier and optionally the second carrier may be transmitting with similar BLER rates (which may be minimal when channel conditions are good).

In block 504, the device processor may tune away from the first subscription to the second subscription. For example, the device processor may perform periodic tune-aways from the active first subscription to the idle second subscription to enable the second subscription to receive paging messages from the second network and/or perform other operations to maintain a connection with the second network. During this time, the first network may send an HS-SCCH control message to the wireless communication device to deactivate the first carrier. However, the RF resource is tuned away from the first subscription and so the wireless communication device will not receive the control message.

In block 506, after completion of the tune-away, the device processor may collect error statistics for the first carrier for a time duration T. The error statistics may be the BLER of the first carrier, which may be determined from the number of ACKs or NACKs received from the first network in response to transmissions through the first carrier. Again, the time duration T may include the time for the first transmission of a HARQ packet and all retransmissions of the HARQ packet through the first carrier after the tune-away is complete. For example, the time duration T may be equal to the round trip time for a transmission between the wireless communication device and the first network multiplied by the number of HARQ retransmissions allowed (e.g., 4 or 8).

In determination block 508, the device processor may determine whether the first network has received at least some transmissions from the first carrier. For example, if the BLER of the first carrier is 100% (i.e., 100% HICH DTx), this indicates that the first network has only sent NACKs (or has not sent any ACKs) and thus has not received any packets from the first carrier.

A BLER rate of less than 100% indicates that the first network has received some packets and thus the cause of the high error rate is likely not because the first network deactivated a carrier and the wireless communication device missed the deactivate control message during the tune-away. Thus, in response to determining that the first network has received at least some transmissions from the first carrier (i.e., determination block 508=“Yes”), the device processor may continue with normal transmission processing in block 518. In other words, if the first network is receiving transmissions from the first carrier (BLER is under 100%), the device processor may continue transmitting from the first carrier. If the BLER rate for the first carrier after the tune-away is different from the BLER rate before the tune-away, it may be an indication of a change in channel conditions.

In response to determining that the first network has not received at least some transmissions from the first carrier (i.e., determination block 508=“No”), the device processor may determine whether the second carrier has transmitted any data during the time duration T in determination block 510. In other words, if the first carrier has a BLER of 100%, the device processor may check whether the second carrier is also transmitting data.

In response to determining that the second carrier has not transmitted data in the time duration T (i.e., determination block 510=“No”), the device processor may route transmissions from the first carrier to the second carrier in block 512.

In response to determining that the second carrier has transmitted data in the time duration T (i.e., determination block 510=“Yes”), or after routing transmissions from the first carrier to the second carrier, the device processor may determine whether the first network has received at least some transmissions from the second carrier in determination block 514. For example, the device processor may collect error statistics for the second carrier for second time duration (which may be of the time duration T or of a different length of time), and determine whether the error rate for the second carrier is 100%, indicating that the first network has not receive at least some transmissions from the second carrier.

In response to determining that the first network has received at least some transmissions from the second carrier (i.e., determination block 514=“Yes”), the device processor may deactivate the first carrier in block 516. In other words, if the first network is receiving transmissions from the second carrier but not the first carrier, this may be an indication that the wireless communication device missed a control message during the tune-away to deactivate the first carrier. Thus the device processor may independently deactivate the first carrier (i.e., deactivate the first carrier without receiving a control message from the network to do so). The device processor may then continue with normal transmission processing using the second carrier in block 518.

In response to determining that the first network has not received at least some transmissions from the second carrier (i.e., determination block 514=“No”), the device processor may continue with normal transmission processing using the second carrier in block 518. In other words, if the first network is not receiving transmissions from both the first and second carriers, this may be an indication of bad channel conditions or causes other than missing a control message to deactivate the first carrier. In this case, the wireless communication device may not be able to correct the transmission problems, and so may continue transmitting according to the normal procedure by keeping the first carrier activated.

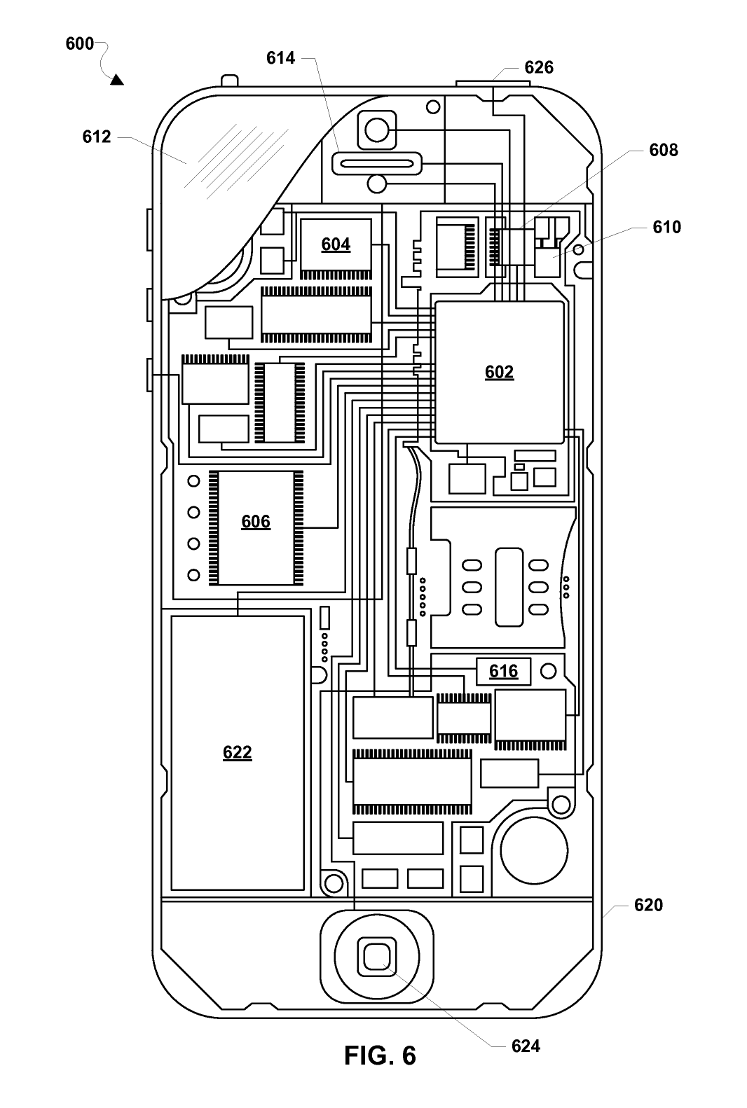

Various embodiments may be implemented in any of a variety of wireless communication devices, an example of which (e.g., wireless communication device 600) is illustrated in FIG. 6. According to various embodiments, the wireless communication device 600 may be similar to the wireless communication devices 110, 120 as described with reference to FIG. 1, as well as multi-SIM communication device 200 and 402 as described with reference to FIGS. 2 and 4. As such, the wireless communication device 600 may implement the method 500 in FIG. 5.

With reference to FIGS. 1, 2, and 4-6, the wireless communication device 600 may include a processor 602 coupled to a touchscreen controller 604 and an internal memory 606. The processor 602 may be one or more multi-core integrated circuits designated for general or specific processing tasks. The internal memory 606 may be volatile or non-volatile memory, and may also be secure and/or encrypted memory, or unsecure and/or unencrypted memory, or any combination thereof. The touchscreen controller 604 and the processor 602 may also be coupled to a touchscreen panel 612, such as a resistive-sensing touchscreen, capacitive-sensing touchscreen, infrared sensing touchscreen, etc. Additionally, the display of the wireless communication device 600 need not have touch screen capability.

The wireless communication device 600 may have one or more cellular network transceivers 608 coupled to the processor 602 and to one or more antennas 610 and configured for sending and receiving cellular communications. The one or more transceivers 608 and the one or more antennas 610 may be used with the herein-mentioned circuitry to implement methods according to various embodiments. The wireless communication device 600 may include one or more SIM cards 616 coupled to the one or more transceivers 608 and/or the processor 602 and may be configured as described herein.

The wireless communication device 600 may also include speakers 614 for providing audio outputs. The wireless communication device 600 may also include a housing 620, constructed of a plastic, metal, or a combination of materials, for containing all or some of the components discussed herein. The wireless communication device 600 may include a power source 622 coupled to the processor 602, such as a disposable or rechargeable battery. The rechargeable battery may also be coupled to the peripheral device connection port to receive a charging current from a source external to the wireless communication device 600. The wireless communication device 600 may also include a physical button 624 for receiving user inputs. The wireless communication device 600 may also include a power button 626 for turning the wireless communication device 600 on and off.

The various embodiments illustrated and described are provided merely as examples to illustrate various features of the claims. However, features shown and described with respect to any given embodiment are not necessarily limited to the associated embodiment and may be used or combined with other embodiments that are shown and described. Further, the claims are not intended to be limited by any one example embodiment.

The foregoing method descriptions and the process flow diagrams are provided merely as illustrative examples and are not intended to require or imply that the operations of various embodiments must be performed in the order presented. As will be appreciated by one of skill in the art the order of operations in the foregoing embodiments may be performed in any order. Words such as “thereafter,” “then,” “next,” etc. are not intended to limit the order of the operations; these words are simply used to guide the reader through the description of the methods. Further, any reference to claim elements in the singular, for example, using the articles “a,” “an” or “the” is not to be construed as limiting the element to the singular.

While the terms “first” and “second” are used herein to describe data transmission associated with a SIM and data receiving associated with a different SIM, such identifiers are merely for convenience and are not meant to limit various embodiments to a particular order, sequence, type of network or carrier.

The various illustrative logical blocks, modules, circuits, and algorithm operations described in connection with the embodiments disclosed herein may be implemented as electronic hardware, computer software, or combinations of both. To clearly illustrate this interchangeability of hardware and software, various illustrative components, blocks, modules, circuits, and operations have been described herein generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present embodiments.

The hardware used to implement the various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine A processor may also be implemented as a combination of computing devices, e.g., a combination of a DSP and a microprocessor, a plurality of microprocessors, one or more microprocessors in conjunction with a DSP core, or any other such configuration. Alternatively, some operations or methods may be performed by circuitry that is specific to a given function.

In one or more exemplary aspects, the functions described may be implemented in hardware, software, firmware, or any combination thereof. If implemented in software, the functions may be stored as one or more instructions or code on a non-transitory computer-readable medium or non-transitory processor-readable medium. The operations of a method or algorithm disclosed herein may be embodied in a processor-executable software module, which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable media may include RAM, ROM, EEPROM, FLASH memory, compact disc read only memory (CD-ROM) or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc in which disks usually reproduce data magnetically, while discs reproduce data optically with lasers. Combinations of the storage media are also included within the scope of non-transitory computer-readable and processor-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the claims. Various modifications to these embodiments will be readily apparent to those skilled in the art, and the generic principles defined herein may be applied to other embodiments without departing from the scope of the claims. Thus, the present disclosure is not intended to be limited to the embodiments shown herein but is to be accorded the widest scope consistent with the following claims and the principles and novel features disclosed herein.

What is claimed is:

1. A method of managing carrier transmissions after a tune-away on a wireless communication device, comprising:
determining whether a first network associated with a first subscription has received transmissions from a first carrier of the first subscription after completion of the tune-away from the first subscription to a second subscription;
determining whether a second carrier of the first subscription is transmitting to the first network after completion of the tune-away in response to determining that the first network has not received transmissions from the first carrier; and
routing transmissions from the first carrier to the second carrier in response to determining that the second carrier is not transmitting to the first network.

2. The method of claim 1, wherein determining whether the first network has received transmissions from the first carrier comprises:
determining an error rate for the first carrier for a time duration after completion of the tune-away; and
determining whether the error rate for the first carrier is 100%.

3. The method of claim 2, wherein the time duration comprises an amount of time required for an initial transmission and all retransmissions of a hybrid automatic repeat request (HARQ) packet.

4. The method of claim 2, wherein the error rate is determined from a number of acknowledgements or non-acknowledgements received from the first network in response to the transmissions from the first carrier.

5. The method of claim 1, further comprising:
determining whether the first network has received transmissions from the second carrier; and
deactivating the first carrier in response to determining that the first network has received transmissions from the second carrier.

6. The method of claim 5, wherein determining whether the first network has received transmissions from the second carrier comprises:
determining an error rate for the second carrier;
determining whether the error rate for the second carrier is 100%; and
determining that the first network has received transmissions from the second carrier in response to determining that the error rate for the second carrier is less than 100%.

7. The method of claim 5, further comprising keeping the first carrier activated in response to determining that the first network has not received transmissions from the second carrier.

8. The method of claim 1, wherein the first carrier is a secondary uplink carrier and the second carrier is a primary uplink carrier of a dual carrier high-speed uplink packet access call.

9. A wireless communication device, comprising:
a radio frequency (RF) resource;
a processor coupled to the RF resource, configured to connect to a first subscriber identity module (SIM) associated with a first subscription and to a second SIM associated with a second subscription, and configured with processor-executable instructions to:
determine whether a first network associated with the first subscription has received transmissions from a first carrier of the first subscription after completion of a tune-away from the first subscription to the second subscription;
determine whether a second carrier of the first subscription is transmitting to the first network after completion of the tune-away in response to determining that the first network has not received transmissions from the first carrier; and
route transmissions from the first carrier to the second carrier in response to determining that the second carrier is not transmitting to the first network.

10. The wireless communication device of claim 9, wherein the processor is further configured with processor-executable instructions to determine whether the first network has received transmissions from the first carrier by:
determining an error rate for the first carrier for a time duration after completion of the tune-away; and
determining whether the error rate for the first carrier is 100%.

11. The wireless communication device of claim 10, wherein the time duration comprises an amount of time required for an initial transmission and all retransmissions of a hybrid automatic repeat request (HARQ) packet.

12. The wireless communication device of claim 10, wherein the processor is further configured with processor-executable instructions to determine the error rate from a number of acknowledgements or non-acknowledgements received from the first network in response to the transmissions from the first carrier.

13. The wireless communication device of claim 9, wherein the processor is further configured with processor-executable instructions to:
determine whether the first network has received transmissions from the second carrier; and
deactivate the first carrier in response to determining that the first network has received transmissions from the second carrier.

14. The wireless communication device of claim 11, wherein the processor is further configured with processor-executable instructions to determine whether the first network has received transmissions from the second carrier by:
determining an error rate for the second carrier;
determining whether the error rate for the second carrier is 100%; and
determining that the first network has received transmissions from the second carrier in response to determining that the error rate for the second carrier is less than 100%.

15. The wireless communication device of claim 13, wherein the processor is further configured with processor-executable instructions to keep the first carrier activated in response to determining that the first network has not received transmissions from the second carrier.

16. The wireless communication device of claim 9, wherein the first carrier is a secondary uplink carrier and the second carrier is a primary uplink carrier of a dual carrier high-speed uplink packet access call.

17. A non-transitory computer readable storage medium having stored thereon processor-executable software instructions configured to cause a processor of a wireless communication device to perform operations comprising:
determining whether a first network associated with a first subscription has received transmissions from a first carrier of the first subscription on the wireless communication device after completion of a tune-away from the first subscription to a second subscription on the wireless communication device;
determining whether a second carrier of the first subscription is transmitting to the first network after completion of the tune-away in response to determining that the first network has not received transmissions from the first carrier; and
routing transmissions from the first carrier to the second carrier in response to determining that the second carrier is not transmitting to the first network.

18. The non-transitory computer readable storage medium of claim 17, wherein the stored processor-executable software instructions are configured to cause the processor to perform operations such that determining whether the first network has received transmissions from the first carrier comprises:
determining an error rate for the first carrier for a time duration after completion of the tune-away; and
determining whether the error rate for the first carrier is 100%.

19. The non-transitory computer readable storage medium of claim 18, wherein the time duration comprises an amount of time required for an initial transmission and all retransmissions of a hybrid automatic repeat request (HARQ) packet.

20. The non-transitory computer readable storage medium of claim 18, wherein the stored processor-executable software instructions are configured to cause the processor to perform operations such that the error rate is determined from a number of acknowledgements or non-acknowledgements received from the first network in response to the transmissions from the first carrier.

21. The non-transitory computer readable storage medium of claim 17, wherein the stored processor-executable software instructions are configured to cause the processor to perform operations further comprising:
determining whether the first network has received transmissions from the second carrier; and
deactivating the first carrier in response to determining that the first network has received transmissions from the second carrier.

22. The non-transitory computer readable storage medium of claim 21, wherein the stored processor-executable software instructions are configured to cause the processor to perform operations such that determining whether the first network has received transmissions from the second carrier comprises:
determining an error rate for the second carrier;
determining whether the error rate for the second carrier is 100%; and
determining that the first network has received transmissions from the second carrier in response to determining that the error rate for the second carrier is less than 100%.

23. The non-transitory computer readable storage medium of claim 21, wherein the stored processor-executable software instructions are configured to cause the processor to perform operations further comprising keeping the first carrier activated in response to determining that the first network has not received transmissions from the second carrier.

24. The non-transitory computer readable storage medium of claim 17, wherein the first carrier is a secondary uplink carrier and the second carrier is a primary uplink carrier of a dual carrier high-speed uplink packet access call.

25. A wireless communication device, comprising:
means for determining whether a first network associated with a first subscription has received transmissions from a first carrier of the first subscription on the wireless communication device after completion of a tune-away from the first subscription to a second subscription on the wireless communication device;
means for determining whether a second carrier of the first subscription is transmitting to the first network after completion of the tune-away in response to determining that the first network has not received transmissions from the first carrier; and
means for routing transmissions from the first carrier to the second carrier in response to determining that the second carrier is not transmitting to the first network.
